(19) United States
(12) Patent Application Publication
(10) Pub. No.: US 2016/0278403 A1
(43) Pub. Date: Sep. 29, 2016

(54) VEGETABLE PROTEIN PRODUCTS AND METHODS FOR MAKING THE SAME

(71) Applicant: Aniceto González Rodríguez, San Luis Potosi (MX)

(72) Inventor: Aniceto González Rodríguez, San Luis Potosi (MX)

(21) Appl. No.: 15/068,617

(22) Filed: Mar. 13, 2016

Related U.S. Application Data
(60) Provisional application No. 62/132,173, filed on Mar. 12, 2015.

(51) Int. Cl. A23L 1/31; A23J 3/22

(52) U.S. Cl. CPC A23L 1/0076; A23L 1/0522; A23J 3/227; A23V 2002/00

(57) ABSTRACT

In one or more embodiments, a vegetable protein product may be produced utilizing an extrusion process. The process may comprise preparing an emulsion of a vegetable protein concentrate and an emulsifier, feeding a tangible mixture into the extruder, introducing the emulsion into the tangible mixture within the extruder to form a combined material, and pushing or driving the combined material through one or more holes at an end of the extruder into an ambient environment.

### FIELD OF THE INVENTION

The invention generally relates to the production of meat substitutes from vegetable matter.

### BACKGROUND

The steady increase of the world population has motivated the search for new food alternatives in order to obtain essential nutrients for human dietary needs. In addition, technological limitations and other factors prevent optimal distribution of food around the planet. Against this background, a growing trend encourages people to consume products of vegetal origin since they are considered healthier due to their low saturated fat and cholesterol content, as well as their high content of dietary fiber. Furthermore, production of vegetable protein is more efficient than animal-based protein.

In this context, there have been attempts to develop compositions and processes for producing suitable meat substitutes from vegetable protein sources. Such is the case of meat analogues made principally of soy protein and with similar color, texture, taste, and form as meat. Those meat analogues are prepared through an extrusion process that utilizing high moisture in order to produce a meat analogue having water content similar to meat (“Wet Meat Substitute Product”). Wet meat substitute products, however, do not store or travel well unless they are refrigerated in the same manner as meat. Such products can be cooked after production in order to drive off at least some of the moisture and improve the stability of the meat substitute. However, such cooking adds a production step, requires time and energy, and may not result in a shelf-stable meat substitute product unless additional steps are taken such as pasteurization and/or refrigeration.

### SUMMARY

A particular embodiment may be directed to vegetable protein meat substitute product (“VPMSP”), which may be formulated and manufactured for consumption. In an embodiment, the meat substitute has low to virtually no cholesterol, and may be low in fat. In an embodiment, the VPMSP may be formulated to increase its weight by approximately 350 to 400% upon hydration. The rehydrated vegetable protein meat substitute product (“RVMPSP”) has physical and sensory properties, and structure, similar to lean beef, chicken or pork. The VPMSP or RVPMSP or “product” may be used hereinafter interchangeably unless otherwise stated. The vegetable protein meat substitute may have functional properties—that is, may be cooked in the same manner as—chicken, beef or pork. Before hydration, the vegetable protein meat substitute may be shaped in a number of geometries or conditions including as tubular pieces of irregular form, and have a fibrous, dry texture. The vegetable protein meat substitute may have a light brown color, which may help provide a meat-like visual cue to the consumer. All percentages are by weight unless otherwise stated (e.g., % by weight).

In an embodiment, an exemplary vegetable protein meat substitute may have any one or more of the following characteristics:
Fibrous structure that approximates to chicken, beef, pork, or fish;
High protein content (such as from about 45% to about 55%);
Low fat (from about 0% to about 10%, normally from about 2 to about 10%);
Cholesterol free or substantially cholesterol free;
High content of Dietary Fiber (such as from about 15%) to about 25%);
Minimal or no refrigeration needed;
High liquid retention capacity (such as about 1:4)
High fat retention capacity (such as about 1:4);
Optimal capacity for flavor of meat and/or seasonings absorption;
Effective control of moisture and water activity;
Long shelf life (such as from about 18 about 24 months).

In an embodiment, VPMSP may be formed from an emulsion mixture and a flour blend. In an embodiment, the emulsion mixture may be formed from at least one emulsifier and at least one mineral salt. In an embodiment, the flour blend may be formed from at least one vegetable protein concentrate comprising at least one vegetable protein, at least one flour, at least one vegetable microfiber, and at least one hydrocolloid.

In an embodiment, an exemplary method for manufacturing a relatively dry VPMSP, which may utilize an extruder, may include making an emulsion including (water, mineral salts, enzymes, vegetable fat, and emulsifiers); introducing a flour blend mixture comprising vegetable protein concentrate, flours, vegetable microfibers and hydrocolloids (together “flour blend”) into a vessel, such as an scraped surface paddle mixer; combining the emulsion with the flour blend, such as by way of introducing the emulsion into the flour blend within the mixer to form a mixture; heating the mixture at a plurality of temperatures, e.g., using an extruder; maintaining the moisture content of the mixtures at a suitable level, such as under about 20% to about 30%; pressurizing the mixture; and discharging the mixture to a suitable environment, such as an ambient environment, for example by advancing the mixture through an aperture at the end of the extruder; providing for the lowering of the moisture content of the mixture, as for example by evaporation. In an embodiment, the lower-moisture mixture may expand over time.

The resultant edible composition of matter may include at least one vegetable protein, at least one flour, at least one vegetable microfiber, at least one emulsifier, at least one hydrocolloid, at least one mineral salt, and at least one enzyme. In an embodiment, the edible composition may further include at least one vegetable fat.

It should be understood that the aforementioned implementations are merely exemplary, and that claimed subject matter is not necessarily limited to any particular aspect of these exemplary implementations.

### BRIEF DESCRIPTION OF THE DRAWINGS

Non-limiting and non-exhaustive features of the present invention are described with reference to the following figures, wherein like reference numerals refer to like parts throughout the various figures.

FIG. 1 is a flowchart for an example process of vegetable protein extrusion, according to an embodiment.

FIG. 2 is a flowchart for an example extrusion process, in accordance with one or more embodiments, such as that of FIG. 1.

FIG. 3 is a flowchart for an example mixture preparation, in accordance with one or more embodiments, such as that of FIG. 1.

FIG. 4 is a flowchart for an example molding process, in accordance with one or more embodiments, such as that of FIG. 1.

FIG. 5 is a flowchart for an example cutting process, in accordance with one or more embodiments, such as that of FIG. 1.

FIG. 6 is a flowchart for an example drying process, in accordance with one or more embodiments, such as that of FIG. 1.

FIG. 7 is a flowchart for an example cutting process, in accordance with one or more embodiments, such as that of FIG. 1.

FIG. 8 is a flowchart for an example packaging process, in accordance with one or more embodiments, such as that of FIG. 1.

FIG. 9 is a flowchart for an example metal detection process, in accordance with one or more embodiments, such as that of FIG. 1.

### DETAILED DESCRIPTION

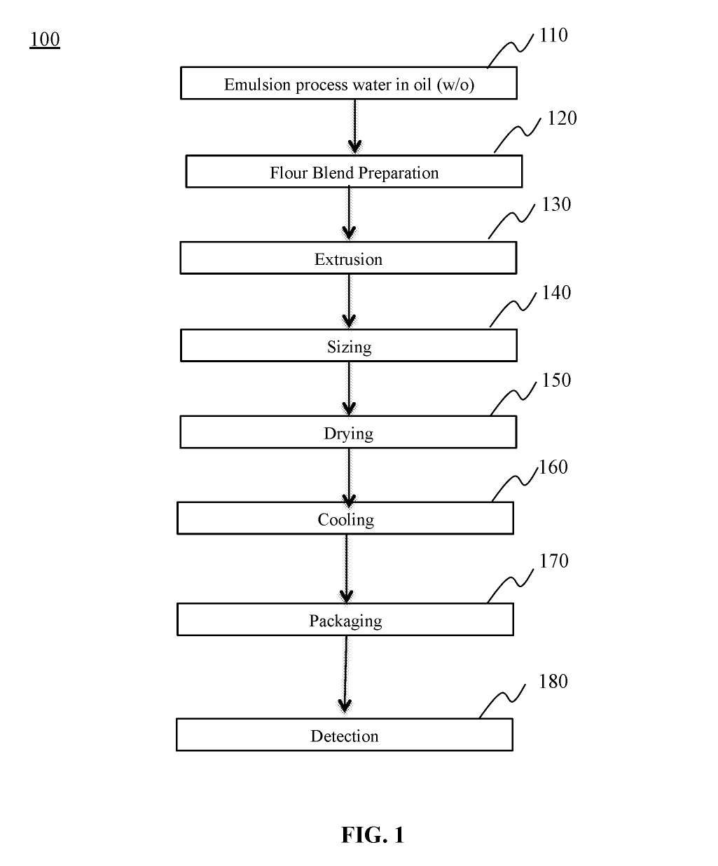

Referring to FIG. 1, an exemplary process 100 for manufacturing a vegetable protein and the various stages (including optional stages) is shown. In an embodiment, the process may comprise preparation of an a water in oil (w/o) emulsion process (110), preparing a flour blend (120), extruding the mixture (130), sizing the resulting mixture (140), drying the mixture (159), cooling the mixture (160); and which may be followed by packaging the cooled mixture (170). The process may further include detection of any portions of undesirable contaminants such as metal (180) that may have been introduced by previous blocks in the process. Some stages, steps or blocks may be performed in parallel or sequential order as may be appropriate and their depiction in the exemplary drawings are not intended to limit such stages, steps, or blocks.

In the drawings certain exemplary parameters are provided but are not intended to necessarily limit the process steps or blocks to those parameters.

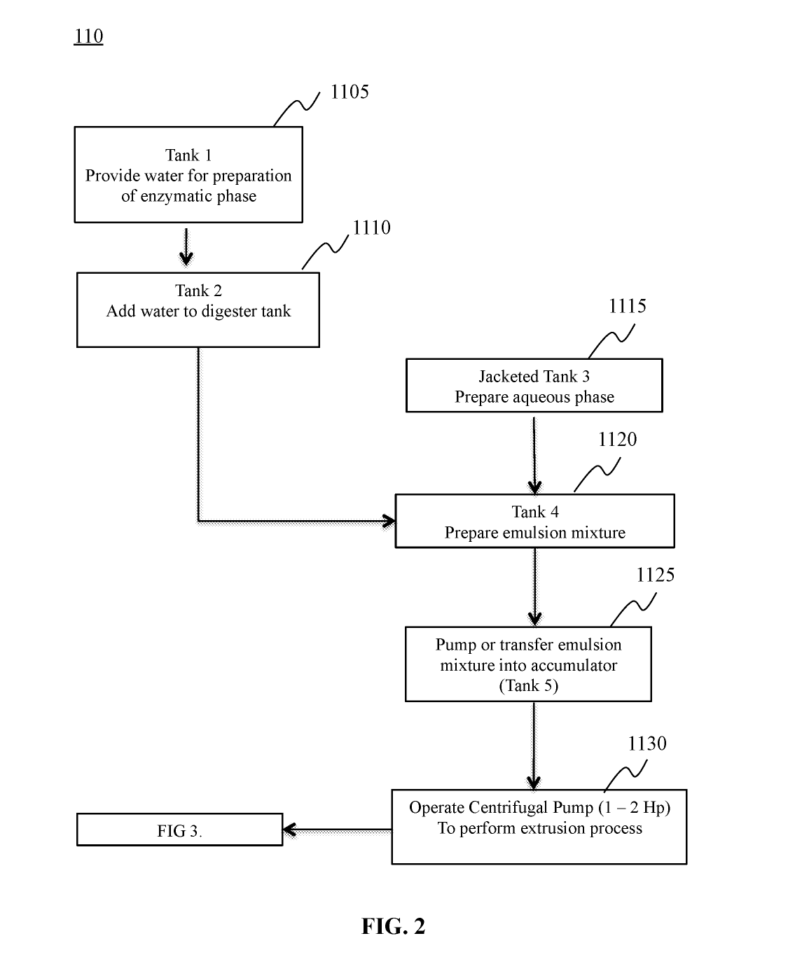

Now referring to FIG. 2, stage 110 is further described using an exemplary process embodying features of claimed subject matter. In a block (1105) a suitable water supply is provided for preparation of an enzymatic phase (Phase A, or aqueous phase, 1110), normally comprising suitable enzymes and mineral salts; usable in the preparation of an emulsion mixture (block 1120). At block 1105, by way of example, a water supply Tank (feed Tank, Tank 1) having a capacity of approximately 5000 L may be utilized at a room temperature (e.g., approximately from about 15° C. to approximately 25° C.). As described herein “room temperature” refers to approximately from about 15° C. to approximately 25° C., unless otherwise stated.

Water may be added to a digester (Tank 2, 1110) from Tank 1 (1105, which may house water at suitable temperate, normally room temperature). The water may be pretreated in any suitable manner, such as de-chlorinated by carbon filtration or, via treatment with potassium metabisulphite. The pH and/or hardness of water in the Tank 1 may be adjusted in any suitable manner. The feed Tank 1 may be of any suitable capacity, and, in an exemplary embodiment, may be sized at 5000 L to support manufacturing operations. Alternately, the feed Tank 1 may be omitted, and water may be received from a municipal source, or an in-situ source (e.g., a source located in the facility where Tank 2 is located), and treated by suitable means such as reverse osmosis.

In an exemplary embodiment, ingredients such as mineral salts and enzymes, at block 1110, are added to a Tank 2 (or digester), which may be a tank, kettle or any other device or mechanism capable of containing a liquid slurry. The mineral salts and enzymes may be stirred at a rate of, for example, between approximately 45 Hz and 70 Hz.

Water may be added from the feed Tank 1 to the Tank 2 before, during, or after the addition of the ingredients to tank 2, normally during mixing of the ingredients.

In an embodiment, mineral salts, enzymes, and/or other suitable ingredients may be added to the feed Tank 1 rather than into the digester directly, such that those ingredients are added to the digester from the feed Tank 1.

The block 1110 of enzymatic phase preparation may be performed at suitable temperature, normally substantially at room temperature. The block 1110 of enzymatic phase preparation may be performed for a suitable duration, usually for about 10 minutes to about 20 minutes.

In block 1115 an aqueous phase (fat phase or phase B) may be prepared in a Tank 3 by preparing an aqueous mix of at least one vegetable fat and at least one emulsifier. In an embodiment, the vegetable fat is heated to suitable temperature, normally from approximately 50° C. to about 60° C. Once the emulsifier is added to Tank 3, the contents are mixed while maintaining a suitable temperature, for example, a stirring rate of approximately 45 Hz to 70 Hz.

Exemplary block 1120, illustrates the preparation of an emulsion mixture, as mixtures of block 110 and 115 are combined to yield an emulsion. Block 1120 may be performed in a Tank 4 or in the same vessel as block 1110 (or 1115). In an exemplary embodiment, the mixture of block 1110 may be introduced, e.g., pumped, or otherwise transferred, to kettle, vessel, or Tank 4 capable of containing a liquid slurry. The block 1120 may be performed at suitable pressure, normally at a high pressure, such as from about 10,340 kPa (1500 Lb./in²) to about 17,240 kPa (2500 Lb./in²), normally, about 10,340 kPa, to promote homogenization. The block 1120 may be performed at a suitable temperature, normally substantially at room temperature (e.g., from approximately 15.0° C. to approximately 25.0° C.). The block 1120 of the emulsion process may be performed for a suitable duration, usually for about 5 to about 15 minutes.

The emulsion mix may include one or more of water, mineral salts, enzymes, vegetable fat, and emulsifiers.

Below, is an example of a set of conditions for carrying out block 1120 of emulsion process oil in water (O/W) of Stage 110:

1. Block 1105—(Tank 1)
Water supply Tank, capacity: 5000 L, Room temperature=approximately 15° C. up to approximately 25° C.

2. Enzymatic phase preparation:
Block 1110 (Phase A, aqueous)—Tank 2
The feed water flow (room temperature) from the Tank 1 to Tank 2 is about 500 cm³/min to about 1500 cm³/min;
Add premix of mineral salts and enzymes, with a stirring rate of approximately 45 Hz to approximately 70 Hz.
Block 1115 (Phase B, Fat)—Jacketed Tank 3
Heat vegetable fat at a temperature of approximately 50° C. to 60° C., add emulsifiers, maintain temperature, and mix with a stirring speed of about 45 Hz to about 70 Hz.

3. Emulsion Process:
Block 1120 (Phase C)—Tank 4
Add Phase B into Tank 4,
Introduce the Phase B in to Phase A
Continue stirring al at a speed of between about 45 Hz to about 70 Hz
High pressure homogenization: about 10,340 kPa to about 17,240 kPa (about 1500 lb./in² to about 2500 lb./in²) Let cool the emulsion to room temperature

Next, in block 1125, the emulsion may be pumped or otherwise transferred to an accumulator Tank 5, or other suitable kettle, vessel, or device capable of containing a liquid slurry. This may be performed at a suitable temperature, normally at room temperature. The emulsion is held in the accumulator Tank 5 until needed.

In an embodiment, if an extruder is utilized, it may be equipped with a jacket (the content of which are isolated from the contents within the extruder) for circulating fluids such as water (e.g., from about 15° C. to about 20° C.). In an embodiment the recirculation cooling process of water serves to control the temperature in the extrusion process. At block 1130, a 1-2 hp pump, for example, may be utilized to perform the extrusion process.

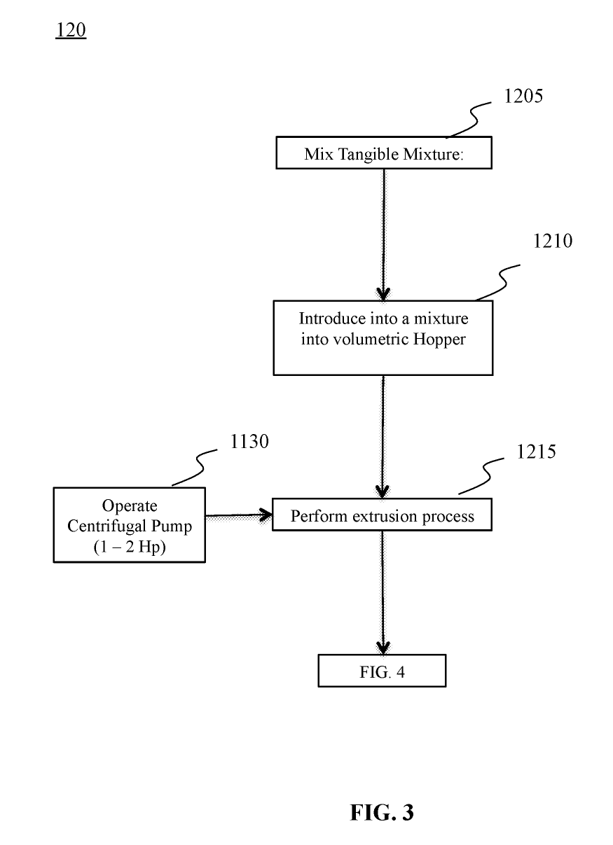

Now referring to FIG. 3, Stage 120 is further described illustrating an exemplary process embodying features of the present invention for making the flour blend. Ingredients for making the flour blend are introduced into a container or vessel. The flour blend of Stage 120 may be formed before, after, or simultaneously, with Stage 110 (of FIG. 1).

The flour blend may include one or more of rice flour, corn flour, wheat flour, soy flour, and any other suitable flour; vegetable protein concentrate; vegetable microfibers; and hydrocolloids blend. The flour blend may form from about 70% to about 85% of the final product, by weight.

The vegetable protein concentrate blend may include one or more of pea protein concentrate, soybean protein concentrate, chickpea protein concentrate, amaranth protein concentrate, or any other suitable vegetable protein concentrate.

The vegetable microfibers may include one or more of oat microfiber, wheat microfiber, apple microfiber, corn fiber, pea fiber, or any other suitable flour.

The emulsifier agents may include one or more of monoglycerides, diglycerides, lecithin, or any other suitable emulsifier.

The hydrocolloid blend may include one or more of carboxymethylcellulose, carrageenan, microcrystalline cellulose, xanthan gum, guar gum, konjac, locust bean, pectin, or any other suitable hydrocolloid.

The mineral salts may include one or more of potassium chloride, calcium, calcium sulfate, magnesium, magnesium carbonate, sodium carbonate, sodium citrate, citric acid, phosphate salts, or any other suitable mineral salts.

The vegetable fat may include one or more of soybean oil, canola oil, safflower oil, or any other suitable vegetable fat.

The enzymes may include one or more of pectinase, hemicellulose, or any other suitable enzymes.

Tank 6 of block 1205 may be sized to accommodate the processing of the block 1205. In one exemplary embodiment, Tank 6 is sized to process approximately 175 kg of flour blend. Tank 6, in an embodiment, may be a jacketed paddle mixer capable of providing sufficient torque to rotate the paddle at a rate of between approximately 14.0 Hz and 20.0 Hz, which is used to make a complete mix of the flour blend and the emulsion (phase C) mix of Stage 110. In an exemplary embodiment, emulsion mix from Stage 110 is introduced into Tank 6. In one embodiment the introduction is by way of injection of the emulsion mix under pressure into the flour blend. In an embodiment such method provides for proper hydration of the resulting mixture of block 1205. The flow of the emulsion into the flour blend may be controlled with precision and may be measured with a flow meter or other device to ensure positive control of emulsion flow.

In an embodiment, the jacketed paddle mixer, the flour mixture from block 1205 is heated, in a jacketed paddle mixture, at a suitable temperature normally from approximately 100° C. to about 140° C., while allowing for the mixture to reach a moisture content of about 40% to about 60%. The hydrated mixture is mixed with the paddles at a suitable speed, normally at a speed of from 800 to about 1200 revolutions per minute (rpm). In an embodiment, the processing of the mixture at appropriate speed may help minimize overheating and burning of the mixture. In an embodiment, using the suitable speed may help decrease the temperature differential (delta T) between the surface and center of the mixer, increasing the heat transfer and decreasing the residence time of the mixture. Without limiting the scope of disclosure, some of the expected advantages may further include energy savings during the manufacturing process. It is further believed, without limiting the scope of the disclosure, that the fat present in the emulsion may have a lubricant effect, reducing the evaporation and decreasing the enthalpy of the block. It is further believed, that the decrease in the residence time while maintaining an effective heat transfer, may provide the partial unfolding of proteins and the hydration of starches and fibers, creation of an increment of the polar sites from the proteins, starches and fiber to caption of water. It is believed, without limiting the scope of the disclosure, that choosing the appropriate speed, temperature, heat transfer, and feeding flow will minimize the formation of “hard centers” (dry large size particles of starch, fibers, vegetable proteins, or combination of thereof) that may act as centers for growth of undesirable product.

At block 1210, the mixture of block 1205 is introduced to a volumetric hopper or other dispenser. The volumetric hopper, in an embodiment, advantageously provides for a substantially constant flow of mixture of block 1205 from the hopper with minimal or no impact from the weight of block 1205 blended in the hopper. The hopper of block 1210 may include a transporting screw/s or other mechanism for delivering the mixture of block 1205 out of the hopper. The hopper may also, or alternatively, include a speed regulator to adjust the discharge volume flow rate from the hopper. The hopper may be sized to accommodate any suitable amount, and in an embodiment approximately 30 kg of the mixture of block 1205.

The volumetric hopper of block 1210 may deliver the mixture to an extruder such as an extruder screw or screws at block 1215. Block 1215 may be accomplished, in an embodiment utilizing, for example, a centrifugal pump having a power output of, for example, and approximately 1 hp to approximately 2 hp. The extruder screw or screws may deliver the mixture into an extruder. The temperature within the extruder may vary along the length of the extruder. In an embodiment, the mixture is exposed to different temperatures as it is moved along the length of the extruder. The extruder may be equipped with electric resistance heating elements (e.g., in its interior). In embodiment the elements help control the temperature at different locations within and along the length of the extruder.

The ingredients may include one or more or all of the vegetable protein, emulsified vegetable fat, minerals, stabilizers, emulsifiers, enzymes, and vegetable lubricant as a processing aid. As one example, the ingredients may be added in the following ratios as provided in Table 1.

TABLE 1
Exemplary ingredient ratios of flour blend:

| | Approximate % |
|---|---|
| COMPOSITION | (by weight) |
| Vegetable protein concentrate | From 40 to about |
| blend | 60 |
| Vegetable microfibers | From 1 to about 5 |
| Emulsifier agents | 0.2-2 |
| Hydrocolloids blend | From 0.1 to about 1 |
| Mineral salts | From 0.05 to about |
| | 0.5 |
| Vegetable fat | From 1 to about 5 |
| Enzymes | From 0.01 to about |
| | 0.1 |

As provided immediately below, in an exemplary embodiment, the extruder may be controlled using parameters described herein and below by a controller, such as a computer or an analog control device.

In an embodiment, as the material moves along the extruder, it may be exposed to different temperature conditions. In an embodiment, the material is exposed to a first temperature T1, followed by exposure to a second temperature T2. In an embodiment, T2, helps prepare the material for gelatinization. At subsequent temperatures T3 and T4, the starches in the material may be gelatinized to form complete or substantially complete denatured proteins. In an embodiment, through the extrusion block 1215, the temperature, shear and low moisture conditions, help modify the structure of the product components and facilitate the reorientation of the molecules to help form a final product with a fibrous texture. These conditions may contribute to the unfolding and denaturation (loss tertiary and quaternary structure by hydrogen and sulfite bonds), while minimizing coagulation (loss structures and solid formation i.e. hard centers) of the vegetables proteins, and help promote the formation of intramolecular (protein-protein) bonds that stabilize the new protein structure. Without limiting the scope of the disclosure, the formation of this new protein polymers of high molecular weight structure is believed to enable formation of texturized product in which long, stable protein fibers are obtained. The gelatinization and melting of starch granules may help increase the ability of those starch molecules and their constituents to bond to water. In an embodiment, after completion of the process, the VPMS at the time of its use will rehydrate at a relatively fast rate, retaining the water, fats, and flavors.

Extrusion Parameters (e.g., utilized for block 1215)—
Twisting force that tends to enable rotation (torque) from 35 Hz to approximately 45 Hz;
Emulsion flow (w/o) from approximately 1400 cm³/hr to approximately 1600 cm³/hr;
Feeding complex from approximately 14 Hz to approximately 20 Hz;
Extrusion temperatures:
T1° C. (flour blend) from 80° C. to about 90° C.;
T2° C. (pregelatinization) from approximately 80° C. to approximately 90° C.;
T3° C. (heating 1) from approximately 175° C. to about 190° C.;
T4° C. (heating 2) from approximately 165° C. to about 175° C.
T5° C. (end of the extruder) from approximately 120° C. to approximately 130° C.

In an embodiment, use of an emulsifier such as a monoglyceride may help promote the formation of emulsifier complexes, such as amylose monoglyceride. Without limiting the scope of the disclosure, it is believed that the binding of fatty acids into such complexes, minimizes the exposure of those fatty acids to oxidation. This minimization may help reduce and/or minimize rancidity reactions. Rancidity reactions may further be minimized due to the inactivation of oxidative enzymes by exposure to the higher temperatures T3 and T4. In an embodiment, temperature ranges of T3 and T4 may be set, in part, to help inactivation of those oxidative enzymes.

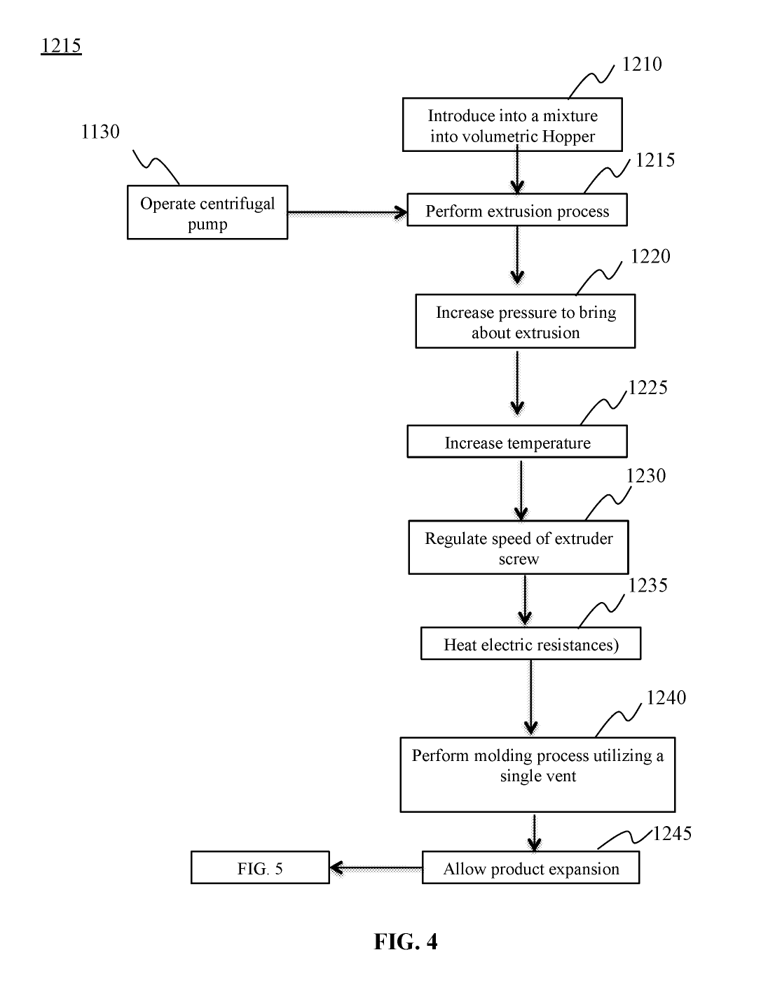

Now referring to FIG. 4, it depicts the extrusion process (1215) utilizing a vertical pump (1130) and a volumetric dispenser (1210). In some embodiments, a mold may be positioned at an end of the extruder. The mold may have any suitable shape. By way of example, the mold may be a plate with a 5 millimeter (mm) aperture (e.g., circular), through which the extruder discharges the product. As the product exits, at block 1220, utilizing a screw, a pressure of between approximately 5 kg/cm² and about 15 kg/cm² is generated. At block 1225, temperature of the mixture may be raised, such as, for example, from about 150° C. to about 250° C. In block 1230, a speed regulator of an extrusion screw, for example, may be set to a value approximately in the range of about 35 Hz to about 45 Hz. At block 1235, heating resistors, such as electric heating resistors, may be utilized to generate a temperature of about 35° C. to about 190° C.

At block 1240, a molding process may utilize a plate utilizing a single vent having a dimension of approximately 3.0 mm to approximate 7.0 mm, utilizing an exemplary pressure of between about 5 kg/cm² to 15 kg/cm², at an exemplary temperature of about 80° C. to about 190° C., and an exemplary moisture content of about 15% to about 25%. At block 1245, the product may be permitted to expand appropriately.

Discharge through the aperture, such as at block 1220, may be brought about in a continuous form, utilizing a high speed spinning blade. As described at block 140 (FIG. 1) a spinning blade may size the product giving the product a specific size (e.g., from about 4 cm to about 8 cm) and particular form, such as a tubular form. The speed of the spinning blade can be modified to get products of several sizes and forms. The size and form of the product may be taken into account as they may affect a drying process. Once the product is sized, it may be transported to a drying oven on a conveyor belt, the product is sized, e.g., cut by a knife (e.g., from about 20 to about 30 shapes of molds available for choice), at a suitable cutting speed, e.g., from about 3 Hz to about 10 Hz.

In an embodiment, the product may be subjected to conditions of high pressure, high temperature, and low moisture within the interior of the extruder. The low moisture of the product increases the viscosity of the melt and increases the shear forces inside the barrel. The conditions reached inside the extruder's barrel influence the proteins to enter into a molten-disorganized state, in which the formation of intramolecular bonds such as hydrophobic bonds, disulfide bonds, and their combinations are achieved. These chemical bonds texturize the product and stabilize the protein matrix, increasing its insolubilization and forming polymers of high molecular weight. In order to facilitate bond formation, low values of moisture are beneficial.

When the product encounters the aperture in the mold at block 1220, it is pushed into the ambient environment, and it undergoes expansion due to the drastic change in conditions, decreasing in density. Furthermore, water in the product evaporates relatively quickly upon exit from the mold, due to the rapid decrease in pressure and temperature of the product as it exits from the aperture/s in the mold, and expands. The evaporation of water at the exit of the extruder die generates a relatively dry product (moisture from about 4% to about 12%) with a low Aw value (from about 0.4 to about 0.8) and a relatively long shelf life. As defined by the Water activity (Aw) is defined as the value of a food is the ratio between the vapor pressure of the food itself, when in a completely undisturbed balance with the surrounding air media, and the vapor pressure of distilled water under identical conditions.

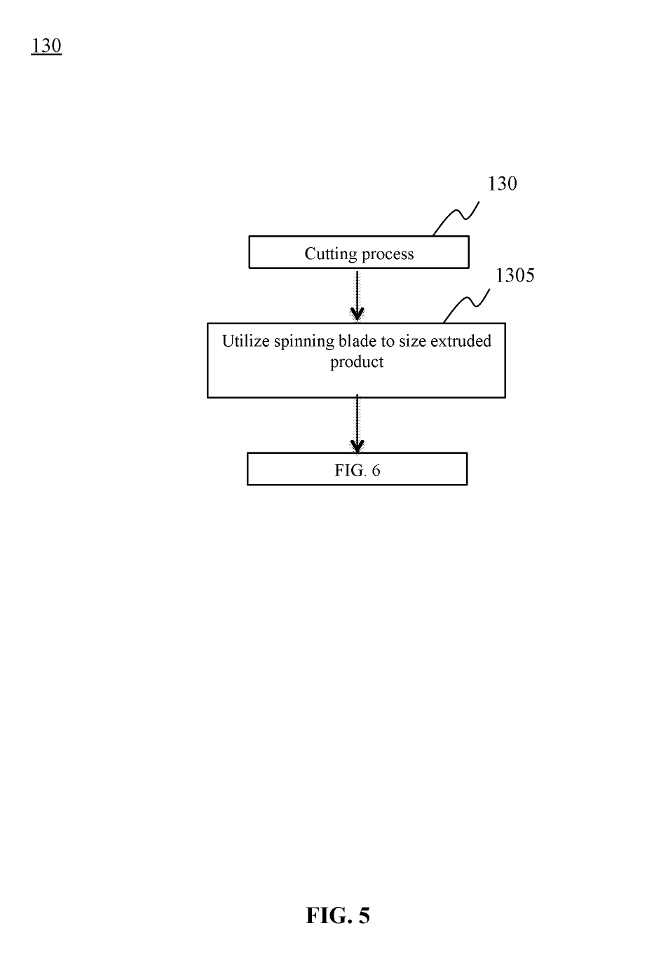

In an embodiment, the product exits the extruder in a continuous form. The form may be tubular, or may be of any other suitable shape. In block 1305 of stage 130 (FIG. 5), a high speed spinning blade, such as a blade spinning at a rate of approximately 3 Hz to 10 Hz, for example, may size the extruded product, giving the product a specific size (such as pieces from about 4 cm to about 8 cm in length) and form (such as tubular). In an embodiment, a knife speed may bring about from about 20 mold shapes to about 30 mold shapes. In this block 1305, the pieces may be cut to any suitable size and form. The speed of the spinning blade may be modified to get products of several sizes and forms. The speed of the spinning blade may be controlled by a speed regulator, which may be a computer or an analog device. Alternately, a reciprocating blade, a wire, or any other suitable cutting implement may be utilized to size the extruded product into a suitable size and form.

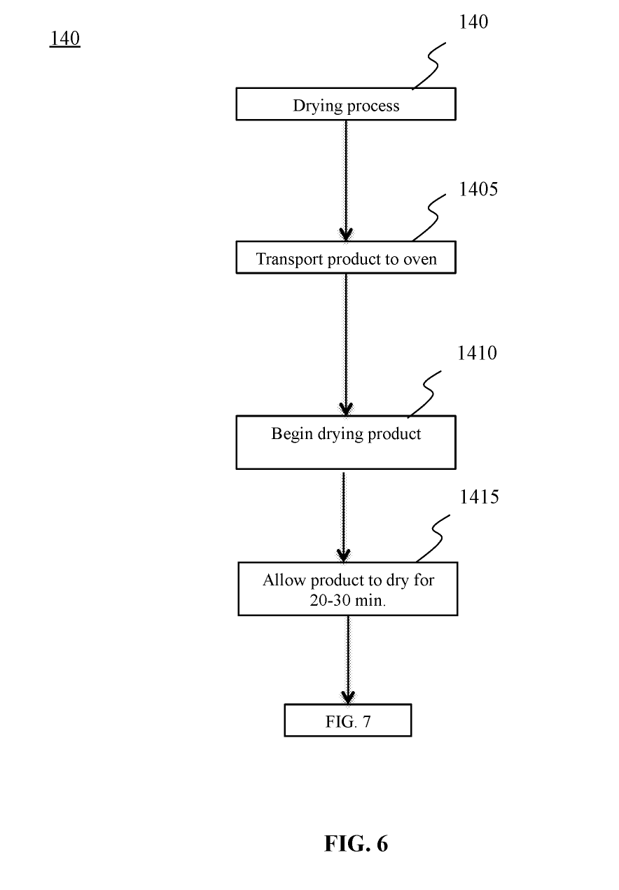

The size and form of the product, as sized during the cutting or sizing process may influence the drying process such as described at 140 of FIG. 6. In block 1405 (FIG. 6), once the product is sized, it is transported to a drying oven, such as by way of a conveyor belt, which may operate at a speed of, for example, between about 15 cm/s to about 30 cm/s. At block 1410, the product may be dried, by way of example in a three-step process, such as, beginning at a temperature of between from about 120° C. to about 150° C., continuing at a temperature of from about 150° C. to about 180° C., and finished utilizing a temperature from about 150° C. to about 190° C. In an embodiment, drying time may approximate from about 20 min. to about 30 min. such as at block 1415.

In an embodiments, the product may be transported to the drying oven by any other continuous mechanism, or by a batch process where batches of sized product are transported to the drying oven in discrete batches, such by the use of baskets. By way of an example, a dehydrator may be used instead of or in addition to a drying oven. The conveyor belt may be made of a stainless steel mesh which extends along the entire drying oven. Drying may be achieved by heating the product with electrical resistance heaters inside the drying oven. The heating temperature within the drying oven may be controlled with thermocouples, and the speed of the conveyor belt through the drying oven may be regulated in order to control the drying time. In an example, the drying time may be from about 20 minutes to about 30 minutes. Other drying times may be utilized as desired. Once the product is completely (or relatively completely) dried, it is transported to the next block of the process by a bucket elevator or other suitable device or method.

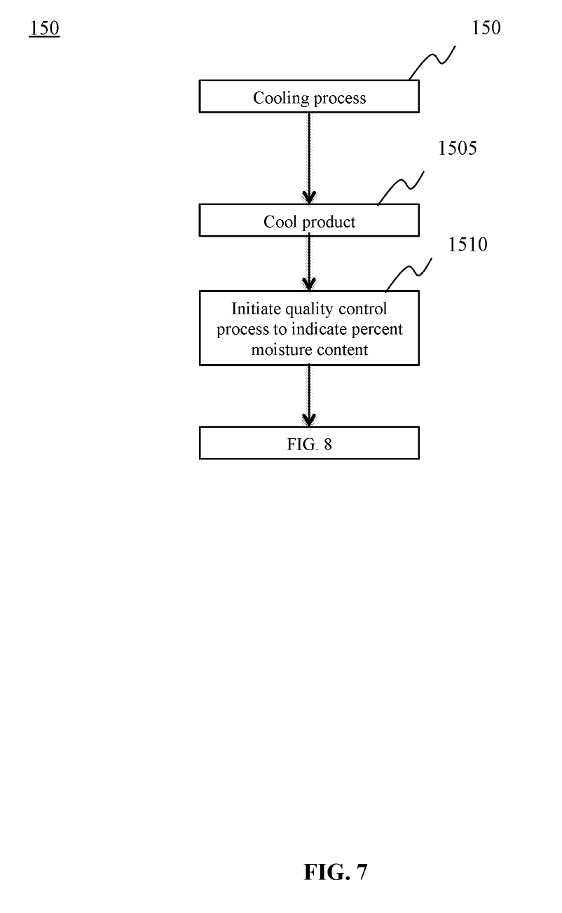

In block 1505 of stage 150 (FIG. 7), the product is let cool. A bucket elevator or conveyor belt, or other suitable device, may carry the product through a cooling tunnel or cooling column, in which cold, dry air contacts the product and dissipates the heat. A fan may be used as part of the cooling block. In an embodiment, a quality-control process, such as at block 1510, may indicate a percent moisture content of between about 3% and about 10%, and a water activity value of between about 0.3% and about 0.7%.

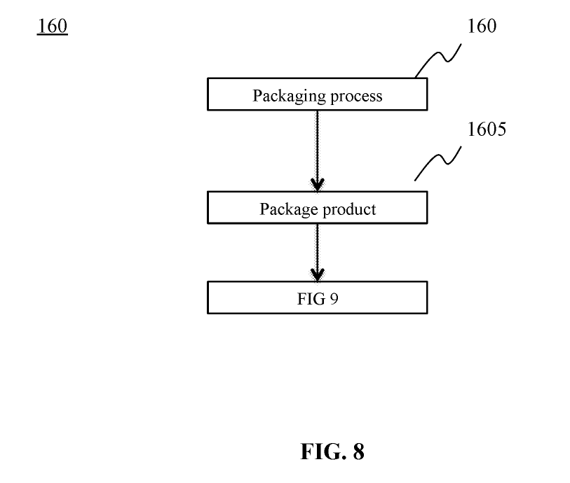

In block 1605 of stage 170 (FIG. 8), the product is packaged. The product, which is relatively dry and stable, may be packaged in any suitable manner. In an example, the product may be packaged in lots of about 15 kg in raffia bags. The bags may then be sewn shut and palletized.

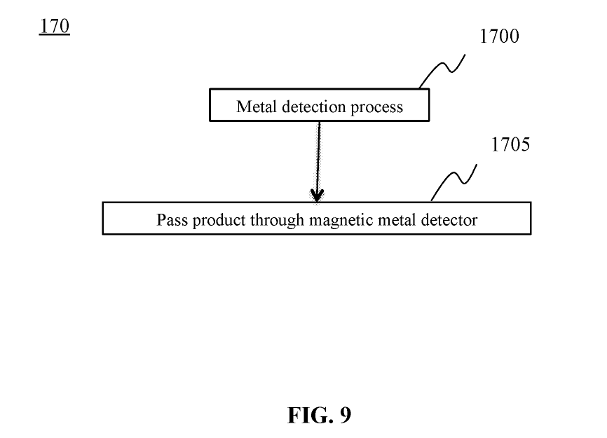

In a final block 1705 of stage 180 (FIG. 9), the packaged product may be passed through a detector to detect undesirable impurities. In an embodiment, the packaged product may be passed through a metal detector, or examined by a moving metal detector, to ensure no metal, such as ferrous metal, is present in the product. The metal detection block 180 may be performed prior to the packaging block 170, if desired. If so, a metal detector may be located at or near the exit of the cooling tunnel or cooling column, such that as the product exits the cooling device, it is checked. An embodiment, block 1705 may utilize distortion of the magnetic field to determine or indicate presence of metal in a finished product. In an embodiment, ferrous or nonferrous metallic portions having a dimension of between 2.0 and 2.5 mm may be detected. In another embodiment, stainless steel metallic portions having a dimension of between 3.0 and 3.5 mm may be detected.

The first three steps may be performed in parallel with the fourth and fifth steps in order to facilitate continuous extrusion.

In an exemplary method of use, water may be added to the product. The product may expand up to approximately 350% to about 400% upon contact with water. For example, to obtain 1 kg of finished product, approximately 0.800 kg of water may be added to about 0.200 kg of the finished, dry product. Due to the low-moisture extrusion of the product as described above, the resultant product rehydrates to a form with texture, properties, and structure similar to lean beef, chicken or pork.

Optionally, quality control of the extruded pieces may be made in order to determine the quality of the prepared vegetable protein. The method may include hydration of the dry extruded pieces, and classification of the pieces as long or short as follows:

Examples of Sample Preparation:

1) Weigh 150 g (+/−2 g) of extruded pieces and place them in a hermetic bag that will be vacuum sealed;

2) Add 600 g of water (T=20-25° C.) or the necessary amount to hydrate in a 1:4 ratio=total weight (750 g);

3) Seal the bag making a knot near to the sample.

Sample Hydration

1) Leave the sample hydrating for 15 min;

2) After 15 min, open the bag and vacuum seal it (−60 cm/Hg);

3) Leave the sample hydrating for another 60 min (vacuum sealed);

4) Open the bag and measure the absorbed water and the remaining water;

Sample Shred

1) Take the extruded and the remaining water inside a blender);

2) Start the shredding process by mixing the sample in the blender for 2 minutes; thereafter cleaning the blender bowl and blades;

3) Restart the mixing process for 4 minutes, then clean the blender bowl and blades again;

4) Once the 6 minutes of the total mixing process have passed, take randomly 200 g of the sample. By way of example, in order to obtain a representative samples, samples are taken from each corner of an imaginary square area;

5) Using the stencil separate the strands in
a) Short strands
b) Long strands
c) The remaining pieces and chunks

Weight of short and long strands

% of short strands=W short strands/200 g (total weight)*100

% of long strands=W short strands/200 g (total weight)*100

% of total strands=% of short strands+% of long strands

| | |
|---|---|
| Length (cm) | Width (cm) |

| | Min | Max | Min | Max |
|---|---|---|---|---|
| Long strands | 4 | 6 | 0.2 | 1.5 |
| Short strands | 2.5 | 3.9 | 0.2 | 1.5 |
| Remaining pieces | <2.5 | <2.5 | <1.5 | <1.5 |
| Chunks | >1.5 | 3 | >1.5 | 3 |

Exemplary Method:

An exemplary method for manufacturing a dry meat substitute using an extruder, comprises:
making an emulsion comprising vegetable protein concentrate blend and emulsifier;
feeding a flour blend (tangible mixture) into the extruder;
introducing said emulsion into said flour blend (tangible mixture) within the extruder to form a combined material;
heating said combined material through a plurality of temperatures;
maintaining the moisture content of said combined material at a level under (about 15%-about 25%);
pressurizing said combined material; and
pushing said combined material through a hole at the end of the extruder into the ambient environment, wherein moisture within said combined material evaporates and said combined material expands.

Exemplary edible composition having features of the present invention, comprises:
at least one vegetable protein concentrate;
at least one flour;
at least one vegetable microfiber;
at least one emulsifier;
at least one hydrocolloid;
at least one mineral salt; and
at least one enzyme.

While blocks of a process 100 have been described in a particular order, those blocks may be performed in any other suitable order.

While the invention has been described in detail, it will be apparent to one skilled in the art that various changes and modifications can be made and equivalents employed, without departing from the present invention. It is to be understood that the invention is not limited to the details of construction, the arrangements of components, and/or the method set forth in the above description or illustrated in the drawings. Statements in the abstract of this document, and any summary statements in this document, are merely exemplary; they are not, and cannot be interpreted as, limiting the scope of the claims. Further, the figures are merely exemplary and not limiting. Topical headings and subheadings are for the convenience of the reader only. They should not and cannot be construed to have any substantive significance, meaning or interpretation, and should not and cannot be deemed to indicate that all of the information relating to any particular topic is to be found under or limited to any particular heading or subheading.

That which is claimed is:

1. A method for manufacturing a dry meat substitute utilizing an extruder, comprising:
preparing an emulsion of a vegetable protein concentrate and an emulsifier;
feeding a tangible mixture into the extruder;
introducing the emulsion into the tangible mixture within the extruder to form a combined material;
pushing the combined material through one or more holes at an end of the extruder into an ambient environment.

2. The method of claim 1, further comprising:
heating the combined material through one or more temperatures ranging from approximately 80° C. to approximately 190° C.

3. The method of claim 2, further comprising:
heating the combined material from approximately 80° C. to approximately 90° C. to permit pregelatinization of the combined material.

4. The method of claim 2, further comprising:
promoting formation of protein polymers comprising protein fibers utilizing a temperature approximately in the range of 175° C. to 190° C.

5. The method of claim 1, further comprising:
maintaining a moisture content of the combined material to a level approximately in the range of 15% to 25%.

6. The method of claim 1, further comprising:
pressurizing the combined material to a pressure approximately in the range of 10,340 kPa to 17,240 kPa.

7. The method of claim 6, further comprising:
promoting homogenization responsive to the pressurizing.

8. The method of claim 1, further comprising:
pushing the combined material through a hole at an end of the extruder into an ambient environment

9. The method of claim 8, further comprising:
evaporating moisture from the combined material to produce a material having a moisture content of between 4% and 12%.

10. An edible composition of matter, comprising:
at least one vegetable protein;
at least one flour;
at least one vegetable microfiber;
at least one emulsifier;
at least one enzyme; and
at least one vegetable fat.

11. The edible composition of claim 10, wherein one or more starches in the edible composition are gelatinized to form a substantially complete denatured proteins.

12. The edible composition of claim 11, wherein the denatured proteins include protein-protein bonds to stabilize a protein structure.

13. The edible composition of claim 11 wherein the edible composition comprises a moisture content of between 4% and 12%.

14. The edible composition of claim 10, further comprising:
at least one hydrocolloid.

15. The edible composition of claim 10, further comprising:
at least one mineral salt.
